(19) United States
(12) Patent Application Publication
(10) Pub. No.: US 2011/0039126 A1
(43) Pub. Date: Feb. 17, 2011

(54) DIE FOR FORMING GLASS SUBSTRATE, METHOD OF MANUFACTURING GLASS SUBSTRATE, METHOD OF MANUFACTURING GLASS SUBSTRATE FOR INFORMATION RECORDING MEDIUM, METHOD OF MANUFACTURING INFORMATION RECORDING MEDIUM, GLASS SUBSTRATE FOR INFORMATION RECORDING MEDIUM, AND INFORMATION RECORDING MEDIUM

(76) Inventor: Hideki Kawai, Hyogo (JP)

Correspondence Address: BRINKS HOFER GILSON & LIONE, P.O. BOX 10395, CHICAGO, IL, 60610, US

(21) Appl. No.: 12/988,583

(22) PCT Filed: Apr. 8, 2009
(86) PCT No.: PCT/JP2009/057189

§ 371 Date: Oct. 19, 2010

(30) Foreign Application Priority Data
Apr. 21, 2008 (JP) 2008-110034

(51) Int. Cl. G11B 5/74; C03B 11/00

(52) U.S. Cl. 428/836; 65/305; 65/93; 428/846.9

(57) ABSTRACT

There are provided a die for forming a glass substrate which does not generate cracks when the glass substrate is released from the die, in a method of manufacturing a glass substrate by forming molten glass with a pressing operation, a method of manufacturing a glass substrate using the die, a method of manufacturing a glass substrate for an information recording medium using a glass substrate manufactured by the method, a method of manufacturing an information recording medium, a glass substrate for an information recording medium, and an information recording medium. In the die for forming a glass substrate used for pressing molten glass to manufacture a glass substrate for an information recording medium, a lower die includes a die surface on which a plurality of grooves or depressions are almost uniformly formed.

### TECHNICAL FIELD

The present invention relates to a die for forming a glass substrate; a method of manufacturing a glass substrate, using the die for forming a glass substrate; a method of manufacturing a glass substrate for an information recording medium, using a glass substrate manufactured with the manufacturing method; a method of manufacturing an information recording medium; a glass substrate for an information recording medium; and an information recording medium.

### BACKGROUND ART

A magnetic disc is one of representative examples of an information recording medium having a recording layer which uses properties such as magnetic properties, optical properties, and magneto-optical properties. As a substrate for a magnetic disc, an aluminum substrate was widely used conventionally. However, a glass substrate has an advantage in smoothness of its surface compared with an aluminum substrate and has less surface discontinuity. Therefore, corresponding to a request to reduce a flying height of a magnetic head for enhancing a recording density, the percentage of glass substrates which are used as a substrate for a magnetic disc is increasing, because the reduction of a flying height of a magnetic disc can be promoted in a glass substrate. Further, in order to save a manufacturing cost of a glass substrate, there is increasing a request to make the thickness of the substrate thinner.

Such a glass substrate for information recording medium such as a magnetic disc, is manufactured by polishing a glass substrate which is called a blank. There are known a method of manufacturing a glass substrate (blank) using a press operation, and a method of manufacturing a glass substrate (blank) by cutting a plate glass formed by a float glass process. Among these methods, the method of manufacturing a glass substrate in which molten glass is directly pressed has attracted attention, because especially high productivity can be expected.

However, the method of manufacturing a glass substrate in which molten glass is pressed, has exhibited a problem that a glass substrate cracks when the glass substrate is removed from a die surface of a die after a pressing operation. Especially, a glass substrate with reduced thickness easily cracks and its productivity is deteriorated, which is a problem.

To solve the problems, there has been proposed a method to enhance a die release property by supplying gas from a through hole arranged on an upper die in a step of opening dies after a pressing operation.

### CITATION LIST

### Patent Literature

Patent Literature 1: JP-A No. 2002-187727

### SUMMARY OF INVENTION

### Technical Problem

However, according to an experiment of the present inventors, the method according to the description of Patent Literature 1 hardly solved the following problem. A glass substrate was partially cooled excessively because of the cooling operation with gas, especially when a thickness of the glass substrate was thinner. Thereby, great distortion remained in the glass substrate, and the glass substrate easily cracked in a pressing operation. Further, a glass material was sometimes engaged with the through hole and its die release property was deteriorated.

The present invention has been achieved in view of the above technical problems. An object of the present invention is to provide a die for forming a glass substrate which does not generate cracks in a thin glass substrate when the glass substrate is released from the die, in a method of manufacturing a glass substrate by forming molten glass with a pressing operation; a method of manufacturing a glass substrate using the die; a method of manufacturing a glass substrate for an information recording medium, using a glass substrate manufactured by the manufacturing method; a method of manufacturing an information recording medium; a glass substrate for an information recording medium; and an information recording medium.

### Solution to Problem

To solve the above problems, the present invention comprises the following features.

1. A die for forming a glass substrate comprising: an upper die and a lower die,

wherein the die for forming a glass substrate is adopted to pressing molten glass and to manufacture a glass substrate for an information recording medium, and

wherein the lower die comprises a die surface on which a plurality of grooves or depressions are formed almost uniformly.

2. The die for forming a glass substrate of Item 1,

wherein the plurality of grooves or depressions are formed into one of a pattern including a plurality of circles whose centers are at a center of the die surface, a pattern in a radiate shape which starts at the center of the die surface, and a pattern including a plurality of regular hexagons.

3. The die for forming a glass substrate of Item 1,

wherein the plurality of grooves or depressions are formed into a pattern including a plurality of circles whose centers are at a center of the die surface.

4. The die for forming a glass substrate of Item 1,

wherein the plurality of grooves or depressions are formed into a pattern in a radiate shape which starts at a center of the die surface.

5. The die for forming a glass substrate of Item 1,

wherein the plurality of grooves or depressions are formed into a pattern including a plurality of regular hexagons.

6. The die for forming a glass substrate of any one of Items 1 to 5,

wherein the plurality of grooves or depressions are formed into a pattern in a rotationally symmetric shape about a center of the die surface.

7. The die for forming a glass substrate of any one of Items 1 to 6,

wherein each of the plurality of grooves or depressions has a cross section in one shape of a rectangular, inverted trapezoid, V shape, curved shape, and polygon.

8. The die for forming a glass substrate of any one of Items 1 to 7,

wherein the plurality of grooves or depressions are 0.02 mm or more and are 0.3 mm or less in depth.

9. The die for forming a glass substrate of any one of Items 1 to 8,

wherein the plurality of grooves or depressions are 0.2 mm or more and are 5 mm or less in width.

10. The die for forming a glass substrate of any one of claims 1 to 9,

wherein an area of the plurality of grooves or depressions within an area where the die surface is in contact with the molten glass, is 1% or more and is 30% or less of the area where the die surface is in contact with the molten glass.

11. The die for forming a glass substrate of any one of Items 1 to 10,

wherein the upper die includes a die surface on which a plurality of grooves or depressions are formed almost uniformly.

12. A method of manufacturing a glass substrate by using the die for forming a glass substrate of any one of Items 1 to 11, the method comprising:

a molten-glass supplying step of supplying molten glass onto the die surface of the lower die in the die for forming a glass substrate; and

a pressing step of pressing the molten glass supplied on the die surface of the lower die with a die surface of the upper die in the die for forming a glass substrate, while cooling the molten glass, to obtain a glass substrate.

13. The method of manufacturing a glass substrate of Item 12, wherein the glass substrate is a glass substrate used for manufacturing a glass substrate for an information recording medium.

14. A method of manufacturing a glass substrate for an information recording medium, the method comprising: a step of polishing a glass substrate manufactured by the method of manufacturing a glass substrate of Item 13, to manufacture a glass substrate for an information recording medium.

15. A method of manufacturing an information recording medium, the method comprising: a step of forming a recording layer on a glass substrate for an information recording medium manufactured by the method of manufacturing a glass substrate for an information recording medium of Item 14, to manufacture an information recording medium.

16. A glass substrate for an information recording medium, manufactured by the method of manufacturing a glass substrate for an information recording medium of Item 14.

17. An information recording medium comprising: a glass substrate for an information recording medium of Item 16, and a magnetic film formed on the surface of the glass substrate.

### Advantageous Effects of Invention

According to the present invention, there can be provided a die for forming a glass substrate such that, even in a thin glass substrate, cracks are not generated when the glass substrate is released from the die. Therefore, there can be provided a method of manufacturing a glass substrate with high productivity, using the die; a method of manufacturing a glass substrate for an information recording medium, using with a glass substrate manufactured by the method; a method of manufacturing an information recording medium; a glass substrate for an information recording medium; and an information recording medium.

### BRIEF DESCRIPTION OF DRAWINGS

FIG. 1 is a diagram showing an example of a die for forming a glass substrate of the present invention.

FIG. 2 is a schematic diagram showing a pattern formed by grooves of a lower die in a die for forming a glass substrate of the present invention.

FIG. 3 is a schematic diagram showing a pattern formed by grooves of a lower die in a die for forming a glass substrate of the present invention.

FIG. 4 is a schematic diagram showing a pattern formed by grooves of a lower die in a die for forming a glass substrate of the present invention.

FIG. 5 is a schematic diagram showing a pattern formed by grooves of a lower die in a die for forming a glass substrate of the present invention.

FIG. 6 is a schematic diagram showing a pattern formed by grooves of a lower die in a die for forming a glass substrate of the present invention.

FIG. 7 is a schematic diagram showing a pattern formed by grooves of a lower die in a die for forming a glass substrate of the present invention.

FIG. 8 is a schematic diagram showing cross-sectional shapes of the grooves of the lower die in the die for forming a glass substrate of the present invention.

FIG. 9 is a schematic diagram illustrating a molten-glass supplying step in which molten glass is supplied onto the lower die in the die for forming a glass substrate of the present invention.

FIG. 10 is a schematic diagram illustrating a pressing step in which the molten glass is pressed with the die for forming a glass substrate of the present invention.

FIG. 11 is a diagram showing an example of a glass substrate for an information recording medium manufactured by a method of manufacturing a glass substrate for an information recording medium of the present invention.

FIG. 12 is a schematic diagram showing a pattern formed by grooves of a lower die in a die for forming a glass substrate of the present invention.

FIG. 13 is a diagram showing a cross section of an example of an information recording medium of the present invention.

### DESCRIPTION OF EMBODIMENTS

Embodiments of the present invention will be described below in detail, with referring to the drawings.

(Die for Forming a Glass Substrate)

In a die for forming a glass substrate of the present invention, a lower die includes a die surface on which a plurality of grooves or depressions are formed almost uniformly, and a glass substrate is manufactured by pressing molten glass with an upper die and the lower die. Further, the upper die preferably includes a die surface on which a plurality of grooves or depressions are formed almost uniformly. By forming the plurality of grooves or depressions on the die surface, a stick property between the die and molten glass becomes weaker when the molten glass is pressed by the upper die and lower die and a formed glass substrate is released from the dies, in other words, a die release property is enhanced. Thereby, cracks are not generated. It is considered that, because the molten glass does not enter a space in the plurality of grooves or depressions completely in the pressing operation, and an air (gas) layer exists between the die and the molten glass to partially act as a heat insulating layer, stick in the die due to burning and sticking on the surface of the die can be avoided and a contacting area of the die and glass is prevented, which acts to enhance the die release property. In the present specification, almost uniformly means that, when the die surface is divided into four equal parts with lines passing through the center of the die surface, variation of an area of the grooves or depressions in each divided part is within ±10%.

As for the plurality of grooves or depressions, it is preferable that there is formed at least one of a pattern including a plurality of circles whose centers are at a center of the die surface, a pattern in a radiate shape which starts at the center of the die surface, and a pattern including a plurality of regular hexagons.

It is preferable that the plurality of grooves or depressions are formed into a pattern in a rotationally symmetric shape about a center of the die surface.

As described above, by providing at least one of a shape of a plurality of circles whose centers are on the center of the die surface, a radiated shape which starts at the center of the die surface, a shape of regular hexagons, and by providing a rotationally symmetric shape about a center of the die surface, as a pattern formed by the plurality of grooves or depressions, it generates uniform stress in a glass substrate in the forming process, which shows an effect to greatly suppress cracking generated in a step of releasing the glass substrate from the die.

As a cross sectional shape of the grooves or depressions, any one of a rectangular, inverted trapezoid, V shape, curved shape, and polygon is preferable. By providing such a cross sectional shape, the glass substrate is released from the die more easily and generation of cracks can be reduced.

It is preferable that the plurality of grooves or depressions are 0.02 mm or more and are 0.3 mm or less in depth. When the depth is less than 0.02 mm, the effect of enhancement of the die release property due to forming the grooves or depressions, is small. When the depth exceeds 0.3 mm, the amount of glass to enter the space of the grooves or depressions increases, the space of the grooves or depressions is excessively heated and a effect of a heat insulating layer becomes insufficient. Thereby, a stick property between the molten glass and the die becomes strong and the die release property is deteriorated, which is undesirable.

It is preferable that the plurality of grooves or depressions are 0.2 mm or more and are 5 mm or less in width. Any of when the width is less than 0.2 mm, and when the width exceeds 5 mm, the die release property of the glass substrate becomes worse, which is undesirable.

It is preferable that an area of the plurality of grooves or depressions within an area where the die surface is in contact with the molten glass, is 1% or more and is 30% or less of the area where the die surface is in contact with the molten glass. The area of the plurality of grooves or depressions means an area occupied with the plurality of grooves or depressions which lie within the same plane to the die surface. When the area is less than 1% or more than 30%, the die release property of the glass substrate becomes worse, which is undesirable.

It is preferable that the molten glass used in the present invention is supplied on the lower die at a temperature from 1000 to 1400° C., and that viscosity coefficient of the molten glass at that time η (Pa·s) is 0.5≦log η≦4.0. It is more preferable that the molten glass is supplied on the lower die at a temperature from 1100 to 1300° C., and that viscosity coefficient of the molten glass at that time η is 1.8≦log η≦3.5.

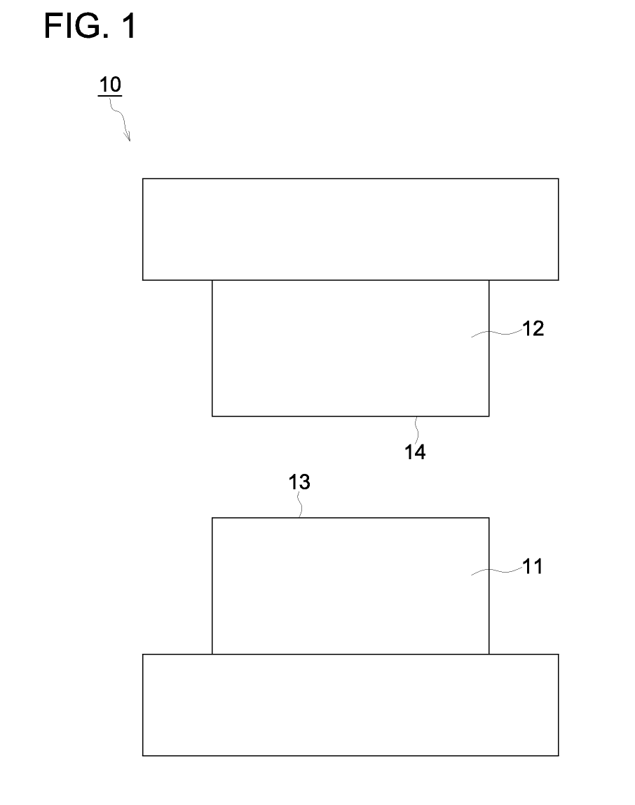

FIG. 1 is a schematic view of a first embodiment of a die for forming a glass substrate of the present invention. Molten glass is supplied on the die for forming a glass substrate 10. The die for forming a glass substrate 10 includes lower die 11 including first die surface 13 for pressing the supplied molten glass, and upper die 12 including second die surface 14 for pressing the molten glass with the die surface 13 of lower die 11.

The die for forming a glass substrate 10 of the first embodiment of the present invention has the same patterns formed by grooves on die surfaces 13 and 14 of upper die 12 and lower die 11, respectively.

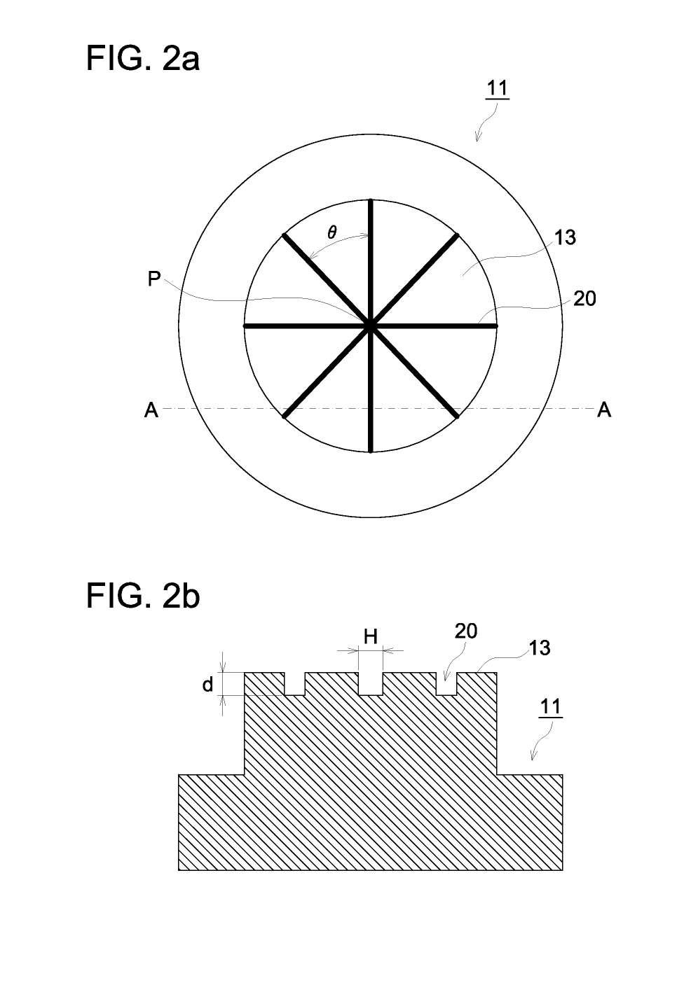

FIG. 2a is a plan view of lower die 11 observed from upward, and FIG. 2b is a sectional view taken along line A-A in FIG. 2a. The first die surface 13 of lower die 11 has the following pattern: there are formed 8 rectangular grooves each of which has a cross section in a rectangular shape and extends from center P in a radial manner, and every angle θ between the grooves is 45 degrees. This pattern is symmetry about the center of die surface 11.

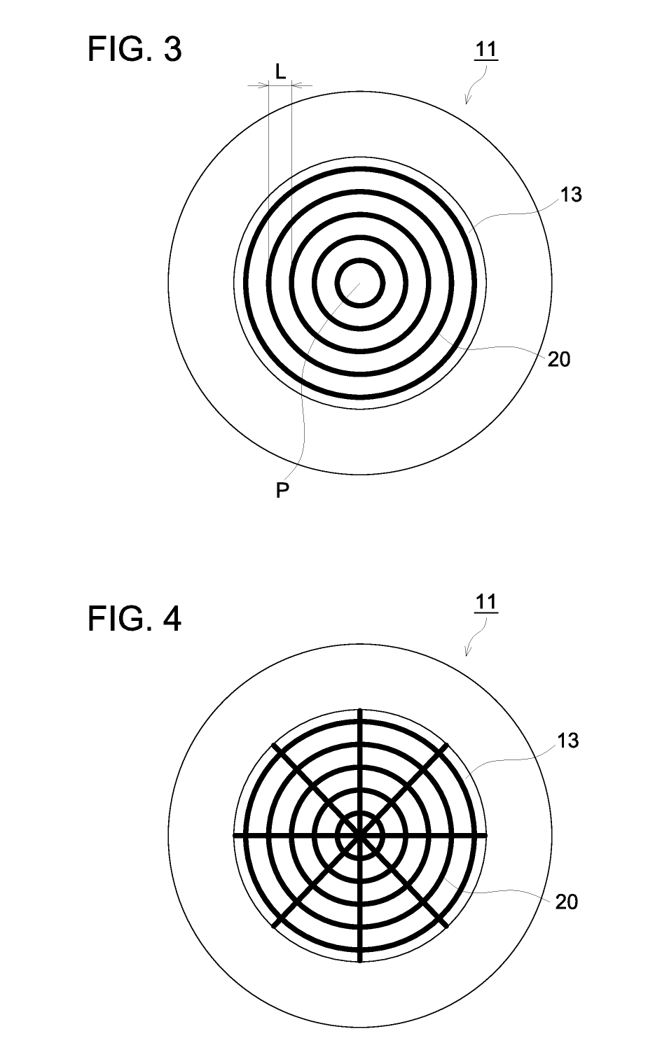

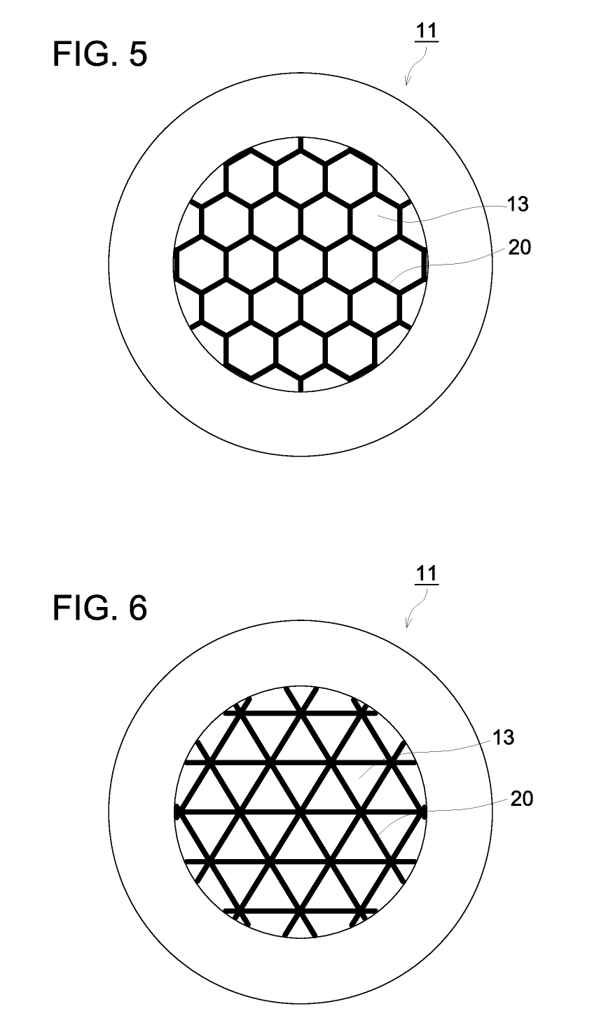

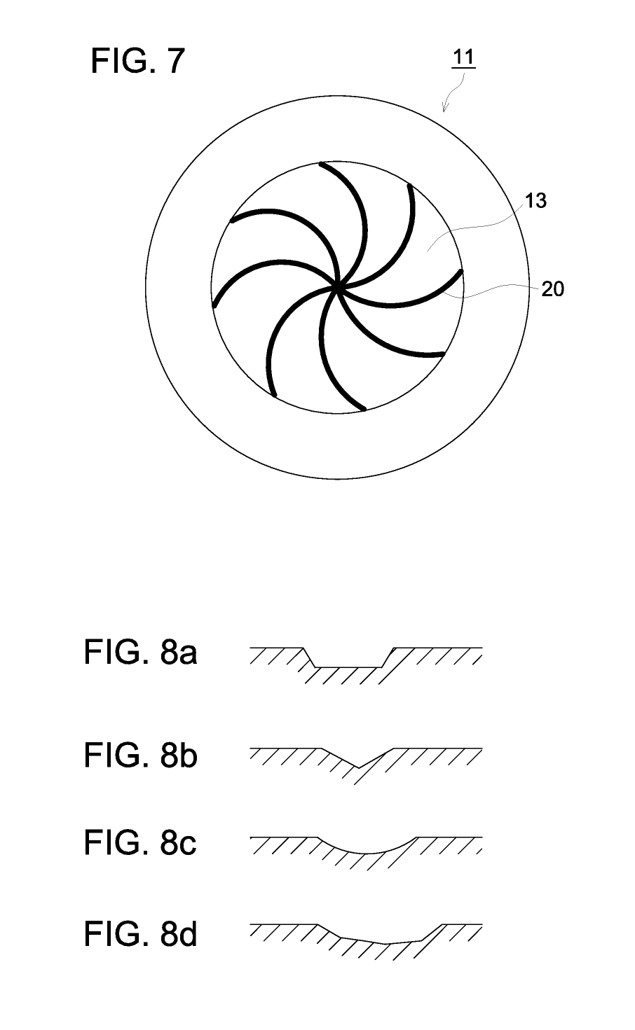

As the pattern, the followings can be used other than that shown in FIG. 2a: a pattern shown in FIG. 3, including a plurality of circles which are arranged at groove interval L with their centers positioned at center P of the die surface; a patter shown in FIG. 4, including radial straight lines extending from the center and concentric circles; a pattern in a shape of plural regular hexagons, shown in FIG. 5; a pattern of combination of plural triangles shown in FIG. 6; and a pattern in which plural curves extending from the center and arranged to be symmetry about the center of the die surface as shown in FIG. 7. The pattern is not limited to these and any pattern can be used as far as it is symmetric about the center of the die surface.

As for a cross-sectional shape of the grooves, rectangular grooves shown in FIG. 2b can be used. Alternatively, various shaped grooves such as inverted-trapezoid grooves in FIG. 8a, V-shaped grooves in FIG. 8b, curve-shaped grooves in FIG. 8c, and polygon grooves in FIG. 8d, can also be preferably used.

Next, a method of manufacturing a glass substrate by using the die for forming a glass substrate will be described.

(Method of Manufacturing a Glass Substrate)

A method of manufacturing a glass substrate in the present invention, is a method in which molten glass is pressed to form a glass substrate. The method includes a molten-glass supplying step in which the molten glass is supplied onto first die surface 13 formed on lower die 11, and a pressing step in which a glass substrate is obtained by pressing the molten glass with first die surface 13 and second die surface 14 formed on upper die 14 while the molten glass is cooled. As the above die, the die for forming a glass substrate of the present invention 10 is employed.

(Molten-Glass Supplying Step)

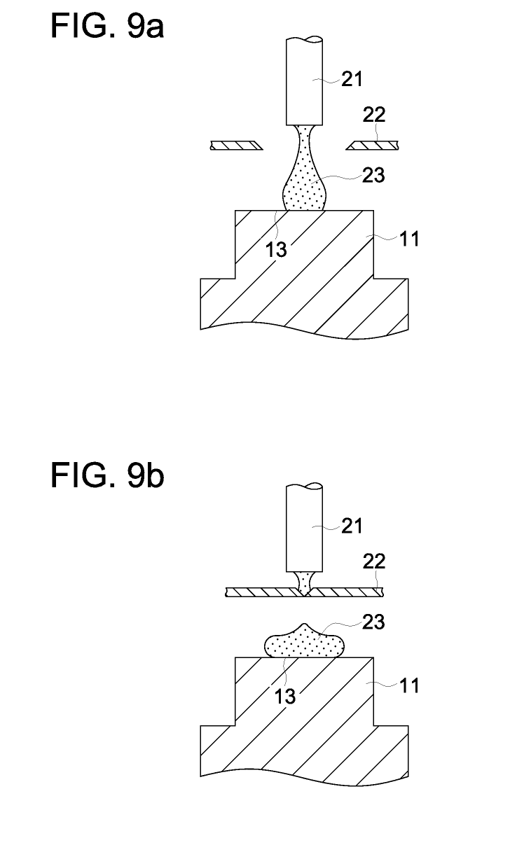

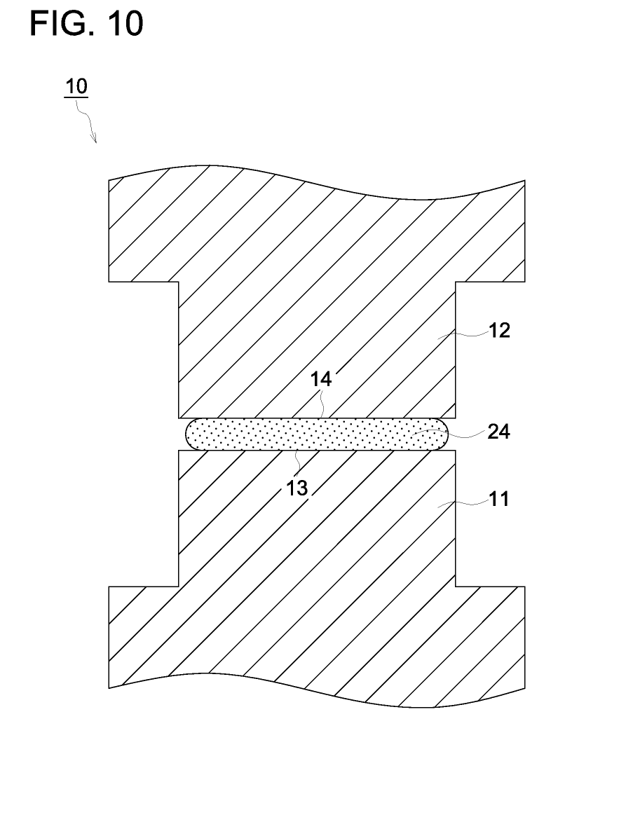

The molten-glass supplying step is a step that molten glass is supplied onto the first die surface formed on the lower die. FIG. 9 shows schematic views illustrating lower die 11 and molten glass 23 in the molten-glass supplying step. First, molten glass 23 is poured through pouring nozzle 21 and is supplied onto lower die 11 (FIG. 9a). After that, the molten glass 23 is cut with blades 22 when the molten glass reaches a predetermined amount, and molten glass 23 is separated (FIG. 9b). Molten glass 23 supplied in the molten-glass supplying step touches with the central portion of first die surface 13 and starts being cooled due to a heat release mainly from the portion which touches with the central portion.

Lower die 11 is heated at a predetermined temperature in advance. The temperature of lower die 11 is not limited especially, and may be determined properly depending on a type of glass and size of the glass substrate. When the temperature of lower die 11 is too low, it causes problems that flatness of the glass substrate is deteriorated, wrinkles are formed in a transferred surface, and the glass is broken because of thermal shock. On the other hand, when the temperature is much higher than it requires, the die is fused with glass and the die is significantly deteriorated, which are not preferable. Normally, it is preferable that the temperature is in a range between Tg (glass transition point) of the glass to be formed minus 20° C. and Tg plus 100° C.

A heating method of lower die 11 is not limited especially, and a proper method can be selected from known heating methods. For examples, cartridge heater to be used by being embedded inside lower die 11, and a heater in sheet-shape to be used by making contact with the outside of lower die 11 can be used. Further, infrared heating unit and high frequency induction heating unit can be used for heating the die.

(Pressing Step)

A pressing step is a step in which the molten glass supplied onto first die surface 13 is pressed with first die surface 13 and second die surface 12 formed on upper die 12 while the molten glass is cooled, to obtain glass substrate 24.

FIG. 10 is a schematic view showing die for forming a glass substrate 10 and glass substrate 24 in the pressing step. Lower die 11 on which molten glass 23 is supplied in the molten-glass supplying step horizontally moves to a position to face upper die 12. After that, the molten glass is pressed with first die surface 13 of lower die 11 and second die surface 14 of upper die 12. The molten glass spreads by the pressing operation to come in contact with the periphery of first die surface 13. The molten glass 23 is cooled and hardened by heat release from its contacting surface with first die surface 13 and second die surface 24, and is formed into glass substrate 24.

Upper die 12 is heated at a predetermined temperature similarly to lower die 11. The heating temperature and heating method are similar to the case of above described lower die 11. The heating temperature may be same as that of lower die 11 and may be different from that of lower die 11.

As a pressing means for pressing the molten glass by applying a load to lower die 11 and upper die 12, known pressing means can be properly selected. For examples, an air cylinder, hydraulic cylinder, and electric cylinder employing a servomotor are cited.

Next, upper die 12 is separated away from glass substrate 24 and the glass substrate is set apart from lower die 11 with an adhesive member.

As described above, in the method of manufacturing a glass substrate of the present invention, there is formed a groove pattern on first die surface 13 as shown in FIG. 2a. It makes easy to release glass substrate 24 from lower die 11 and reduces generation of cracks and scratches. Further, when glass substrate 24 becomes thinner in thickness, it tends to crack also when the upper die is released. In the embodiment of the present invention, groove pattern is formed also on die surface 14 of upper die 12, and generation of cracks and scratches can be reduced even when upper die 12 is removed, which is preferable.

(Method of Manufacturing a Glass Substrate for an Information Recording Medium)

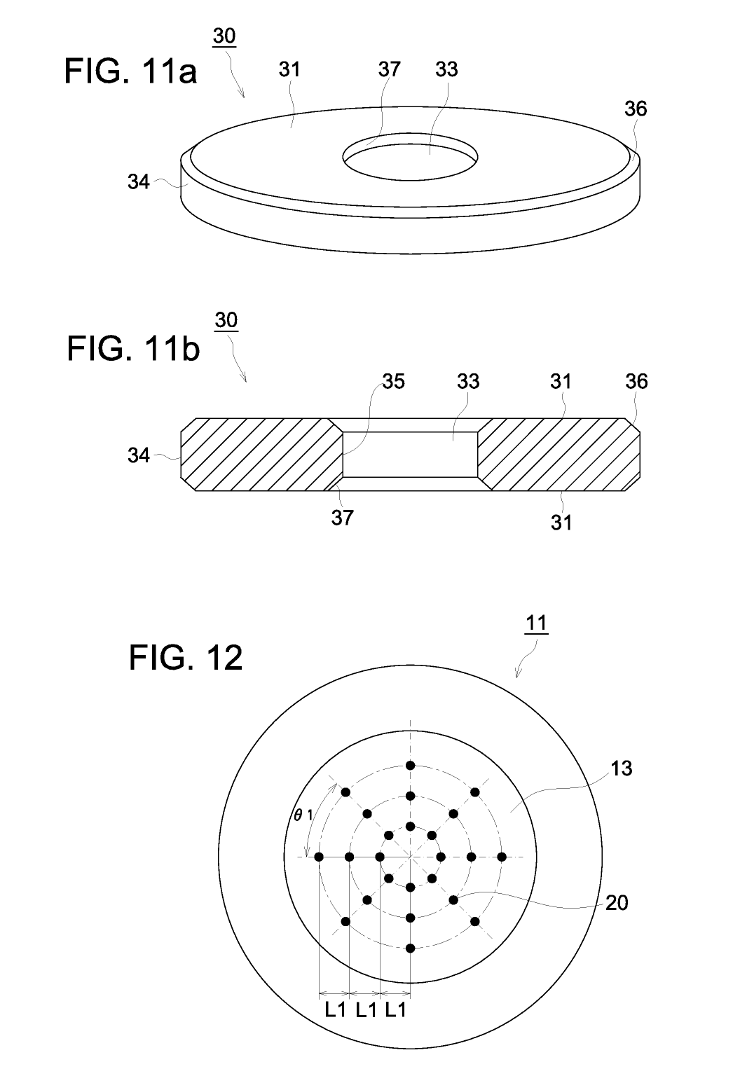

A glass substrate for information recording medium can be manufactured by adding at least a polishing step to a glass substrate (blank) manufactured by the above manufacturing method. FIG. 11 shows diagrams illustrating an example of a glass substrate for an information recording medium manufactured by the method of manufacturing a glass substrate for an information recording medium of the present invention. FIG. 11a is a perspective view and FIG. 11b is a sectional view. Glass substrate for an information recording medium 30 is a glass substrate in circular disc shape with center hole 33, and is composed of main surface 31, outer peripheral edge surface 34, and inner peripheral edge surface 35. Chamfered corners 36 and 37 are formed on the outer peripheral edge surface 34 and inner peripheral edge surface 35, respectively.

The polishing step is a step of polishing a main surface of a manufactured glass substrate (blank) to be finished finally the glass substrate so as to have a smoothness required as a glass substrate for an information recording medium. As a polishing method, a well-known methods used as a manufacturing method of a glass substrate for an information recording medium can be used as it is. For example, two pads are pasted on faces of two rotatable machine platens such that the two pads face to each other, and a glass substrate is arranged between the two pads. In the above arrangement, the two pads are rotated while being in contact with the surfaces of the glass substrate and simultaneously a polishing agent is fed onto the surfaces of the glass substrate, whereby a polishing step is conducted. Further, it is also desirable to separate the polishing step into plural steps, such as a rough polishing process and a precise polishing process by changing the grain size of a polishing agent and the kind of pads.

As a polishing agent, for example, cerium oxide, zirconium oxide, aluminium oxide, manganese oxide, colloidal silica, diamond, and the like may be employed. Among the above agents, it may be preferable to use cerium oxide, because since it has a high reactivity with glass, a smooth polished surface can be obtained for a short time by the use of it.

Although the pad can be separated into a hard pad and a soft pad, a pad can be chosen suitably and can be used as required. As a hard pad, a pad made from a material, such as a hard velour, a urethane foaming, a pitch containing suede, and the like may be employed. As a soft pad, a pad made from a material, such as suede, velour, and the like may be employed.

Further, in the method of manufacturing a glass substrate for an information recording medium according to the present invention, it is desirable to conduct an inner and outer periphery treating step and a lapping step in addition to a polishing step to polish a main surface of a glass substrate (blank). The inner and outer periphery treating step is a process of conducting a step of piercing a central hole, a grinding step to secure the shape of an outer peripheral edge surface and an inner peripheral edge surface and a dimensional accuracy and a polishing step for an inside and outside peripheral edge surfaces. The lapping step is a process of conducting a lapping process before a polishing step in order to satisfy the flatness of a plane on which a recording layer is formed, thickness, parallel accuracy, and the like. Furthermore, in the case of employing a chemically strengthened glass or a crystallized glass as a material of a glass substrate, a chemically strengthening step to conduct ion exchange by immersing a glass substrate in a heated chemically strengthening treatment liquid, a crystallizing step to conduct crystallizing by a heat treatment and the like can be conducted suitably if needed. Each step of the inner and outer peripheral treating step, the lapping step, the chemically strengthening step, and the crystallizing step can be conducted by a method having been used usually as a method of manufacturing a glass substrate for an information recording medium.

Here, in the producing method of a glass substrate for an information recording medium according to the present invention, various processes other than the above may be conducted. For example, an annealing process to conduct a heat treatment to ease an internal strain of a glass substrate, a heat shock process to confirm the reliability of the strength of a glass substrate, a cleaning process to remove foreign matters, such as a polishing agent and a chemically strengthening treatment liquid which remains on the surface of a glass substrate, various inspection and evaluation processes, and the like may be conducted.

There is no specific restriction in the material of a glass substrate, and materials capable of being used as a material of a glass substrate for an information recording medium can be chosen suitably and can be used. Among the materials, a chemically strengthened glass and a crystallized glass are especially desirable, because they are excellent in shock resistance and resistance to vibration. As a glass material capable of being chemically strengthened, for example, soda lime glass composed of SiO₂, Na₂O, and CaO as principal components; aluminosilicate glass composed of SiO₂, Al₂O₃, R₂O (R═K, Na, Li) as principal components; borosilicate glass; Li₂O—SiO₂ system glass; Li₂O—Al₂O₃—SiO₂ system glass; R′O—Al₂O₃—SiO₂ system glass (R′═Mg, Ca, Sr, Ba) and the like can be employed.

There is also no specific restriction in the size of a glass substrate. For example, glass substrates with outside diameters of various sizes, such as 2.5 inches, 1.8 inches, 1 inch, and 0.8 inches may be employed. Further, there is also no specific restriction in the thickness of a glass substrate. For example, glass substrates with various thicknesses, such as 1 mm, 0.64 mm, and 0.4 mm may be employed.

(A Method of Manufacturing an Information Recording Medium)

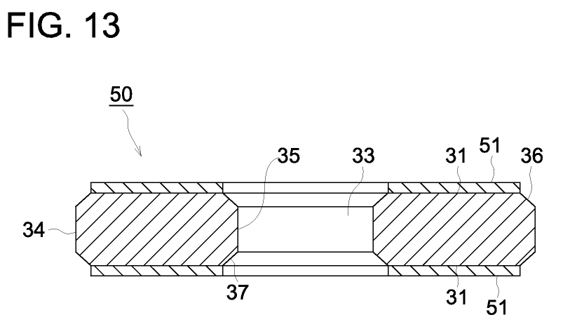

An information recording medium can be manufactured by at least forming a recording layer on a glass substrate for an information recording medium according to the present invention. FIG. 13 shows a cross section of an information recording medium 50 in which recording later 51 is formed on main surface 31 of glass substrate for information recording medium 30. The recording layer is not limited specifically so that various recording layers utilizing properties such as magnetic properties, optical properties, and magneto-optical properties can be used. Especially, it is suitable to use a magnetic layer as the recording layer for manufacturing an information recording medium (magnetic disc).

As magnetic materials used for a magnetic layer, there is no specific restriction, and well-known materials can be chosen suitably and can be used. For example, magnetic materials containing Co as a principal component, such as CoPt, CoCr, CoNi, CoNiCr, CoCrTa, CoPtCr, CoNiPt, CoNiCrPt, CoNiCrTa, CoCrPtTa, and CoCrPtSiO may be used. Further, a multilayer structure may be employed by dividing a magnetic layer with non-magnetic layers (for example, Cr, CrMo, and CrV) into layers, in order to reduce noise.

As a magnetic layer, employed is a granular with a structure in which magnetic particles, such as Fe, Co, CoFe, and CoNiPt, are dispersed into a nonmagnetic layer composed of a ferrite system material, an iron-rare earth system material, SiO₂, BN or the like in addition to the above-mentioned Co system material. Magnetic layers may be any one of an in-plane type and vertical type.

As a method of forming a magnetic layer, a well-known method can be employed. For example, a sputtering method, a non-electrolytic plating method, a spin coat method, and the like are listed.

The magnetic disc may be further provided with a foundation layer, a protective layer, a lubricating layer, and the like as needed. For each of these layers, well-known materials are suitably chosen and can be used. As materials of a foundation layer, for example, Cr, Mo, Ta, Ti, W, V, B, Al, Ni and the like can be used. As materials of a protective layer, for example, Cr, a Cr alloy, C, ZrO₂, SiO₂ and the like are listed. Further, as a lubricating layer, employed are, for example, materials coated with a liquid lubricant composed of perfluoropolyether (PFPE) and subjected to heat treatment if needed.

### Examples

### Examples 1-22

For Examples 1 to 13 representing Type 1 of a die for forming a glass substrate, there was used a die including plural grooves which radiate from the center of the die surface shown in FIG. 2, on each of die surfaces of the upper die and lower die. Table 1 shows angle θ formed between the respective grooves, width of the grooves H, depth of the grooves d, cross-sectional shape, and area ratio S, for the dies of Examples 1 to 13, where the area ratio is a ratio of an area of the grooves out of an area where the die surface is in contact with the molten glass.

For Examples 14 to 16 representing Type 2 of a die for forming a glass substrate, there was used a die including plural grooves which form a plurality of circles whose centers are at a center of the die surface shown in FIG. 3, on each of die surfaces of the upper die and lower die. Table 2 shows interval L between center P of the die surface and the center of the most-inner groove, or between the respective neighboring grooves, width of the grooves H, depth of the grooves d, cross-sectional shape, and area ratio S, for the dies of Examples 14 to 16, where the area ratio is a ratio of an area of the grooves out of an area where the die surface is in contact with the molten glass.

For Examples 17 to 22 representing Type 3 of a die for forming a glass substrate, there was used a die employing a pattern in which plural circular depressions are symmetrically arranged about the center of the die surface shown in FIG. 12, on each of die surfaces of the upper die and lower die. Table 3 shows diameter d1 of circular depressions 20, distance L1 from the center of the die surface, angle θ1 formed between neighboring circular depressions, depth d2 of the depressions 20, cross-sectional shape, and area ratio S, for the dies of Examples 14 to 16, where the area ratio is a ratio of an area of the depressions out of an area where the die surface is in contact with the molten glass. In these examples, circular depressions had the same cross-sectional shape to a rectangular groove.

SUS310S was used for the upper die and the lower die, and there were provided a die surface including a same pattern of grooves or depressions for each of the upper die and the lower die.

After both of the upper die and the lower die were heated at 400° C. and molten glass was supplied onto the first die surface of the lower die, the molten glass was pressed between the first die surface and the second die surface of the upper die. Borosilicate glass was employed as a glass material. After the glass was pressed with the upper and lower dies for five seconds, the upper die was removed and a glass substrate was released. The outer diameter of the glass substrate was about 70 mm, and the thickness of the glass substrate was about 1 mm.

### Example 23

In Example 23, a glass substrate was manufactured similarly to Example 3, other than a structure that grooves on the die surface of the upper die were not formed.

### Example 24

In Example 24, a glass substrate was manufactured similarly to Example 8, other than a structure that grooves on the die surface of the upper die of Example 8 were not formed.

### Example 25

In Example 25, a glass substrate was manufactured similarly to Example 12, other than a structure that grooves on the die surface of the upper die of Example 12 were not formed.

### Comparative Example 1

In Comparative example 1, a glass substrate was manufactured similarly to Example 1, other than a structure that grooves on the die surface of the lower die of Example 1 were not formed.

### Comparative Example 2

In Comparative example 2, a glass substrate was manufactured similarly to Example 1, other than a structure that grooves on the die surfaces of the upper die and lower die of Example 1 were not formed.

### Comparative Example 3

In Comparative example 3, a glass substrate was manufactured similarly to Example 17, other than a structure that one depression with diameter of 1.5 mm and depth of 0.1 mm was formed at the center instead of arranging plural circular depressions on the die surface symmetrically about the center of the die surface as shown in Example 17, and that grooves were not formed on the die surface of the upper die.

### (Evaluation)

Evaluations of a die release property of the glass substrate when the upper die was separated away from the glass substrate; and a die release property of the glass substrate when the glass substrate was released from the lower die were carried out based on existence of forming defects such as a broken part, chip, and crack generated in the glass substrate, observed after the glass substrate was released. After 100 sheets of glass substrates were manufactured, a substrate in which forming defects are not generated at all was evaluated as a symbol “A”, a substrate in which one forming defect was generated was evaluated as a symbol “B”, and a substrate in which two or more forming defects were generated was evaluated as a symbol “C”. Tables 1 to 3 show the evaluation results.

TABLE 1

| | | Number of | | | | | |
|---|---|---|---|---|---|---|---|
| | | grooves | | | | | |
| | | passing | Width of | Depth of | | | |
| | Angle | through the | grooves H | grooves d | Sectional shape | Area ratio | Evaluation |
| | θ (°) | center | (mm) | (mm) | of grooves | S (%) | result |
| Example 1 | 45 | 4 | 0.5 | 0.015 | Rectangular | 3.6 | B |
| | | | | | groove | | |
| Example 2 | 45 | 4 | 0.5 | 0.020 | Rectangular | 3.6 | A |
| | | | | | groove | | |
| Example 3 | 45 | 4 | 0.5 | 0.100 | Rectangular | 3.6 | A |
| | | | | | groove | | |
| Example 4 | 45 | 4 | 0.5 | 0.300 | Rectangular | 3.6 | A |
| | | | | | groove | | |
| Example 5 | 45 | 4 | 0.5 | 0.350 | Rectangular | 3.6 | B |
| | | | | | groove | | |
| Example 6 | 90 | 2 | 0.15 | 0.100 | Rectangular | 0.5 | B |
| | | | | | groove | | |
| Example 7 | 90 | 2 | 0.2 | 0.100 | Rectangular | 0.7 | A |
| | | | | | groove | | |
| Example 8 | 90 | 2 | 3 | 0.100 | Rectangular | 10.9 | A |
| | | | | | groove | | |
| Example 9 | 90 | 2 | 5 | 0.100 | Rectangular | 18.2 | A |
| | | | | | groove | | |
| Example 10 | 90 | 2 | 5.2 | 0.100 | Rectangular | 18.9 | B |
| | | | | | groove | | |
| Example 11 | 45 | 4 | 0.5 | 0.100 | Inverted- | 3.6 | A |
| | | | | | trapezoid groove | | |
| Example 12 | 45 | 4 | 0.5 | 0.100 | V-shaped | 3.6 | A |
| | | | | | groove | | |
| Example 13 | 45 | 4 | 0.5 | 0.100 | Curve-shaped | 3.6 | A |
| | | | | | groove | | |
| Example 23 | 45 | 4 | 0.5 | 0.100 | Rectangular | 3.6 | B |
| | | | | | groove | | |
| Example 24 | 90 | 2 | 3 | 0.100 | Rectangular | 10.9 | B |
| | | | | | groove | | |
| Example 25 | 45 | 4 | 0.5 | 0.100 | V-shaped | 3.6 | B |
| | | | | | groove | | |
| Comparative | 45 | 4 | 0.5 | 0.015 | Rectangular | 3.6 | C |
| example 1 | | | | | groove | | |
| Comparative | — | — | — | — | — | — | C |
| example 2 | | | | | | | |

TABLE 2

| | | Number of | Width of | Depth of | | Area | |
|---|---|---|---|---|---|---|---|
| | Interval | concentric | grooves H | grooves d | Sectional shape | ratio S | Evaluation |
| | L (mm) | circles | (mm) | (mm) | of grooves | (%) | result |
| Example 14 | 3 | 11 | 0.5 | 0.100 | Inverted- | 16.2 | A |
| | | | | | trapezoid groove | | |
| Example 15 | 5 | 7 | 1 | 0.100 | Rectangular | 22.9 | A |
| | | | | | groove | | |
| Example 16 | 10 | 3 | 2 | 0.100 | Curve-shaped | 19.6 | A |
| | | | | | groove | | |

TABLE 3

| | | | Number of | | Depth of | | |
|---|---|---|---|---|---|---|---|
| | Distance | Angle | circular | Diameter | depressions | Area ratio S | Evaluation |
| | L1 (mm) | θ1 (°) | depressions | d1 (mm) | (mm) | (%) | result |
| Example 17 | 20 | 45 | 8 | 1.5 | 0.1 | 0.4 | B |
| Example 18 | 20 | 45 | 8 | 2.5 | 0.1 | 1.0 | A |
| Example 19 | 20 | 45 | 8 | 5.0 | 0.1 | 4.1 | A |
| Example 20 | 10 | 45 | 24 | 4.0 | 0.1 | 7.8 | A |
| Example 21 | 10 | 10 | 108 | 3.7 | 0.1 | 30.2 | A |
| Example 22 | 10 | 10 | 108 | 4.0 | 0.1 | 35.3 | B |
| Comparative | — | — | 1 | 2.0 | 0.1 | 0.1 | C |
| example 3 | | | | | | | |

As can be seen from the results of Examples 1 to 25 and Comparative examples 1 to 3 in Tables 1 to 3, a release property of the glass substrate after a press forming is enhanced and cracks and scratches generated in the releasing operation can be suppressed, by providing a plurality of grooves or depressions on a die surface of the lower die of the die for forming a glass substrate. Comparing Examples 3, 8, and 11 with Examples 23, 24, and 25, it can be seen that providing grooves or depressions also on the die surface of the upper die is preferable. Comparing Examples 1 to 5 with each other, it can be said that a preferable depth of the grooves or depressions is 0.02 mm or more and is 0.3 mm or less. Comparing Examples 6 to 10 with each other, it can be said that the preferable width of the grooves or depressions is 0.2 mm or more and is 5 mm or less. As can be seen from the results of Examples 11 to 16, any sectional shapes of grooves of rectangular shape, inverted-trapezoid, V-shape, curved-shape, and polygon exhibited preferable results. As can be seen from the results of Examples 17 to 22, it is found that the preferable area ratio S which is a ratio of an area of the plurality of grooves or depressions out of an area where the die surface is in contact with the molten glass, is from 1% to 30%.

### REFERENCE SIGNS LIST

10 Die for forming a glass substrate

11 Lower die

12 Upper die

13 First die surface

14 Second die surface

20 Grooves

23 Molten glass

24 Glass substrate

30 Glass substrate for an information recording medium

50 Information recording medium

1. A die for forming a glass substrate comprising:
an upper die, and
a lower die,
wherein the die for forming a glass substrate is adopted to pressing molten glass and to manufacture a glass substrate for an information recording medium, and
the lower die comprises a die surface on which a plurality of grooves or depressions are formed almost uniformly.

2. The die for forming a glass substrate of claim 1,
wherein the plurality of grooves or depressions are formed into one of
a pattern including a plurality of circles whose centers are at a center of the die surface,
a pattern in a radiate shape which starts at the center of the die surface, and
a pattern including a plurality of regular hexagons.

3. The die for forming a glass substrate of claim 1,
wherein the plurality of grooves or depressions are formed into a pattern including a plurality of circles whose centers are at a center of the die surface.

4. The die for forming a glass substrate of claim 1,
wherein the plurality of grooves or depressions are formed into a pattern in a radiate shape which starts at a center of the die surface.

5. The die for forming a glass substrate of claim 1,
wherein the plurality of grooves or depressions are formed into a pattern including a plurality of regular hexagons.

6. The die for forming a glass substrate of claim 1,
wherein the plurality of grooves or depressions are formed into a pattern in a rotationally symmetric shape about a center of the die surface.

7. The die for forming a glass substrate of claim 1,
wherein each of the plurality of grooves or depressions has a cross section in one shape of a rectangular, inverted trapezoid, V shape, curved shape, and polygon.

8. The die for forming a glass substrate of claim 1,
wherein the plurality of grooves or depressions are 0.02 mm or more and are 0.3 mm or less in depth.

9. The die for forming a glass substrate of claim 1,
wherein the plurality of grooves or depressions are 0.2 mm or more and are 5 mm or less in width.

10. The die for forming a glass substrate of claim 1,
wherein an area of the plurality of grooves or depressions within an area where the die surface is in contact with the molten glass, is 1% or more and is 30% or less of the area where the die surface is in contact with the molten glass.

11. The die for forming a glass substrate of claim 1,
wherein the upper die includes a die surface on which a plurality of grooves or depressions are formed almost uniformly.

12. A method of manufacturing a glass substrate by using the die for forming a glass substrate of claim 1, the method comprising:
a molten-glass supplying step of supplying molten glass onto the die surface of the lower die in the die for forming a glass substrate; and
a pressing step of pressing the molten glass supplied on the die surface of the lower die with a die surface of the upper die in the die for forming a glass substrate, while cooling the molten glass, to obtain a glass substrate.

13. The method of manufacturing a glass substrate of claim 12,
wherein the glass substrate is a glass substrate used for manufacturing a glass substrate for an information recording medium.

14. A method of manufacturing a glass substrate for an information recording medium, the method comprising:
a step of polishing a glass substrate manufactured by the method of manufacturing a glass substrate of claim 13, to manufacture a glass substrate for an information recording medium.

15. A method of manufacturing an information recording medium, the method comprising:
forming a recording layer on a glass substrate for an information recording medium manufactured by the method of manufacturing a glass substrate for an information recording medium of claim 14, to manufacture an information recording medium.

16. A glass substrate for an information recording medium, manufactured by the method of manufacturing a glass substrate for an information recording medium of claim 14.

17. An information recording medium comprising:
a glass substrate for an information recording medium of claim 16, and
a magnetic film formed on the surface of the glass substrate.
